(19) United States
(12) Patent Application Publication
(10) Pub. No.: US 2008/0282855 A1
(43) Pub. Date: Nov. 20, 2008

(54) WATER JET CUTTING METHOD

(75) Inventor: Shigekazu Kanai, Ota-Ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/104,972

(22) Filed: Apr. 17, 2008

(30) Foreign Application Priority Data
May 16, 2007 (JP) 2007-130936

(51) Int. Cl. B26D 7/00

(52) U.S. Cl. 83/22

(57) ABSTRACT

A package base is held on a holding table, and an XYZ moving mechanism is next moved to adjust a jet position to a cutting start point of a primary subject line to be first cut. Thereafter, a cutting water supplying unit is operated to direct a water jet onto the package base at this cutting start point. Thereafter, the XYZ moving mechanism is operated to move the package base, thereby cutting the package base along the primary subject line until a cutting stop point. Similarly, this cutting operation is repeated for the other primary subject line to thereby obtain a plurality of primary cut areas having the same shape and size in the condition that each primary cut area is integrally supported at its opposite ends to the package base, thus finishing a primary cutting step. Thereafter, a dicing tape is attached to one side surface of the package base. Thereafter, the package base is cut along a plurality of secondary subject lines as in the primary cutting step, thus finishing a secondary cutting step.

### BACKGROUND OF THE INVENTION

1. Field of the Invention

The present invention relates to a method of cutting a workpiece such as a substrate, and more particularly to a method of cutting a workpiece by jetting a high-pressure cutting water to the workpiece.

2. Description of the Related Art

A plurality of individual devices such as semiconductor chips are fabricated by partitioning the surface of a wafer into a plurality of rectangular areas arranged like a matrix, forming an electronic circuit such as IC (Integral Circuit) or LSI (Large Scale Integration) in each rectangular area, and cutting the wafer along a plurality of cutting lines defining the rectangular areas therein. The wafer is cut by using a dicing device having a cutting blade or a laser cutting device using laser light. In some case, each device is packaged by a packaging technique called CSP (Chip Size Package) intended to downsizing.

In a QFN (Quad Flat Non-leaded) package as an example of the CSP technique, a substrate such as a copper plate is partitioned into a plurality of lead frames each having a device size, and a device is mounted on each lead frame in a stacked manner. Each device is sealed with resin to fabricate a CSP substrate. Thereafter, the CSP substrate is cut to separate the lead frames from each other. Generally, the CSP substrate is cut by using a dicing device. However, there is a case that burrs due to the cutting of the CSP substrate invite a short circuit in a lead terminal, causing a reduction in quality. Accordingly, in recent years, a water jet cutting device has been used to cut the CSP substrate by jetting a high-pressure cutting water containing abrasive powder to the CSP substrate.

A cutting method for a CSP substrate by using such a water jet cutting device is described in Japanese Patent Laid-open No. 2005-271120, for example. This cutting method includes a primary cutting step and a secondary cutting step to be performed separately from each other. In each cutting step, the CSP substrate is cut along a continuous cutting line like a single-stroke drawing. Further, between the primary cutting step and the secondary cutting step, a protective sheet attaching step is performed to attach a protective sheet to the surface of the CSP substrate. Accordingly, possible scattering of the individual devices cut from the CSP substrate after the secondary cutting step can be prevented by the protective sheet.

In the primary cutting step of the cutting method described in Japanese Patent Laid-open No. 2005-271120, the CSP substrate is cut like a comb. Accordingly, each cut area is supported at its one end to the substrate, so that each cut area suffers warping because of a stress originally existing in the substrate, resulting in projection in the direction substantially along the thickness of the substrate. In the case that the protective sheet attaching step and the secondary cutting step are next performed in the warped condition of the CSP substrate, there is a possibility of occurrence of various troubles such as an error in transporting the substrate and an error in attaching the protective sheet. Further, there is a possibility that the accuracy of cutting in the secondary cutting step may be reduced in the warped condition of the substrate.

### SUMMARY OF THE INVENTION

It is therefore an object of the present invention to provide a water jet cutting method for cutting a workpiece such as a substrate by using a water jet cutting device which can suppress various troubles in cutting the workpiece and can efficiently cut the workpiece with a desired accuracy.

In accordance with an aspect of the present invention, there is provided a water jet cutting method using a water jet cutting device including holding means for holding a platelike workpiece, cutting water supplying means for supplying a high-pressure cutting water, a nozzle for jetting the cutting water supplied from the cutting water supplying means toward the workpiece held by the holding means, and jet position moving means for relatively moving the nozzle and the holding means to change a jet position of the cutting water jetted from the nozzle onto the workpiece, wherein a plurality of straight and/or curved cutting lines are set on the workpiece, and the workpiece is cut along the cutting lines by jetting the cutting water from the nozzle and operating the jet position moving means, thereby obtaining a plurality of partitioned portions having the same shape and size, the cutting method including a primary cutting step for cutting the workpiece along a first group of the cutting lines to form a plurality of primary cut areas having the same shape and size in the condition where at least one end of each primary cut area is integrally supported to the workpiece; an adhesive member attaching step for attaching an adhesive member to one side surface of the workpiece; and a secondary cutting step for cutting the primary cut areas along the other group of the cutting lines to obtain the partitioned portions.

The cutting method of the present invention includes the primary cutting step and the secondary cutting step to be separately performed. Between the primary cutting step and the secondary cutting step, the adhesive member attaching step is performed to attach the adhesive member to one side surface of the workpiece in order to prevent scattering of the individual portions of the workpiece after the secondary cutting step. In the primary cutting step, the workpiece is cut along the first group of the cutting lines to obtain the plural primary cut areas having the same shape and size in the condition that at least one end of each primary cut area is integrally supported to the workpiece. Accordingly, unlike the prior art, each primary cut area is not always supported at its one end. In other words, each cut area is supported at its opposite ends or at its one end. Even in the latter case, the length of each primary cut area supported at its one end can be made relatively small. As a result, the degree of warping and projection of each cut area of the workpiece can be suppressed.

After the primary cutting step, the adhesive member attaching step is performed to attach the adhesive member to one side surface of the workpiece. After the adhesive member attaching step, the secondary cutting step is performed to cut the workpiece along the other group of the cutting lines to obtain the plural partitioned portions having the same shape and size. Accordingly, it is possible to prevent the occurrence of various troubles after the primary cutting step, such as an error in attaching the adhesive member to the workpiece in the adhesive member attaching step. As a result, the secondary cutting step can be smoothly performed to improve the accuracy of the partitioned portions finally obtained by this cutting method.

Preferably, the cutting along the cutting lines in the primary cutting step and/or the secondary cutting step is performed continuously over at least two of the plural partitioned portions. In this case, the time for stopping the supply of the cutting water during cutting of the workpiece can be reduced, so that the overall cutting operation time can be reduced to thereby make the cutting operation more efficient.

Preferably, the cutting start and stop points of each cutting line in the primary cutting step and/or the secondary cutting step are set outside of a cutting area defined by the outermost ones of the plural cutting lines. In cutting the workpiece by using the water jet cutting device, the cutting water contains abrasive powder, so that there is a possibility of erosion on the surface of the workpiece subject to the jet of the cutting water. That is, when the jet of the cutting water containing abrasive powder is directed onto the workpiece, the cutting water scatters about a jet point on the workpiece. As a result, the abrasive powder contained in the cutting water and the particles of the material of the workpiece as cut by the abrasive powder are deposited on the surface of the workpiece, thus causing the erosion. At the cutting start and stop points, the time for jetting of the cutting water is relatively long, so that the influence of erosion at the cutting start and stop points may become larger than that at the other points on each cutting line. To cope with this problem, the cutting start and stop points are set outside of the cutting area according to the present invention to thereby suppress the influence of erosion on the partitioned portions of the workpiece.

According to the present invention, the warping of the workpiece after the primary cutting step can be suppressed to thereby prevent various troubles after the primary cutting step. As a result, the workpiece can be efficiently cut with a desired accuracy.

The above and other objects, features and advantages of the present invention and the manner of realizing them will become more apparent, and the invention itself will best be understood from a study of the following description and appended claim with reference to the attached drawings showing some preferred embodiments of the invention.

### BRIEF DESCRIPTION OF THE DRAWINGS

FIGS. 1A to 1C are perspective views showing a fabrication procedure for a package base to be cut according to a preferred embodiment of the present invention;

FIG. 2 is a perspective view of a water jet cutting device according to the preferred embodiment;

FIG. 3A is a perspective view showing a primary cutting step of a water jet cutting method according to the preferred embodiment;

FIG. 3B is a plan view of the package base in the progress of the primary cutting step;

FIG. 4A is a perspective view showing a secondary cutting step of the cutting method according to the preferred embodiment;

FIG. 4B is a plan view of the package base in the progress of the secondary cutting step;

FIG. 5A is a plan view showing a cutting path in a primary cutting step of the prior art cutting method;

FIG. 5B is a side view of the package base cut in the primary cutting step shown in FIG. 5A;

FIG. 5C is a plan view showing a cutting path in a secondary cutting step of the prior art cutting method;

FIG. 6A is a plan view of a package base in a modification of the preferred embodiment, wherein the package base has cutting lines different in shape from those of the package base shown in FIG. 3B and the primary cutting step is shown;

FIG. 6B is a plan view showing the secondary cutting step for the package base shown in FIG. 6A;

FIG. 7A is a plan view similar to FIG. 6A, showing another modification; and

FIG. 7B is a plan view similar to FIG. 6B, showing the modification of FIG. 7A.

### DETAILED DESCRIPTION OF THE PREFERRED EMBODIMENT

A preferred embodiment of the present invention will now be described with reference to the drawings.

### [1] Package Base

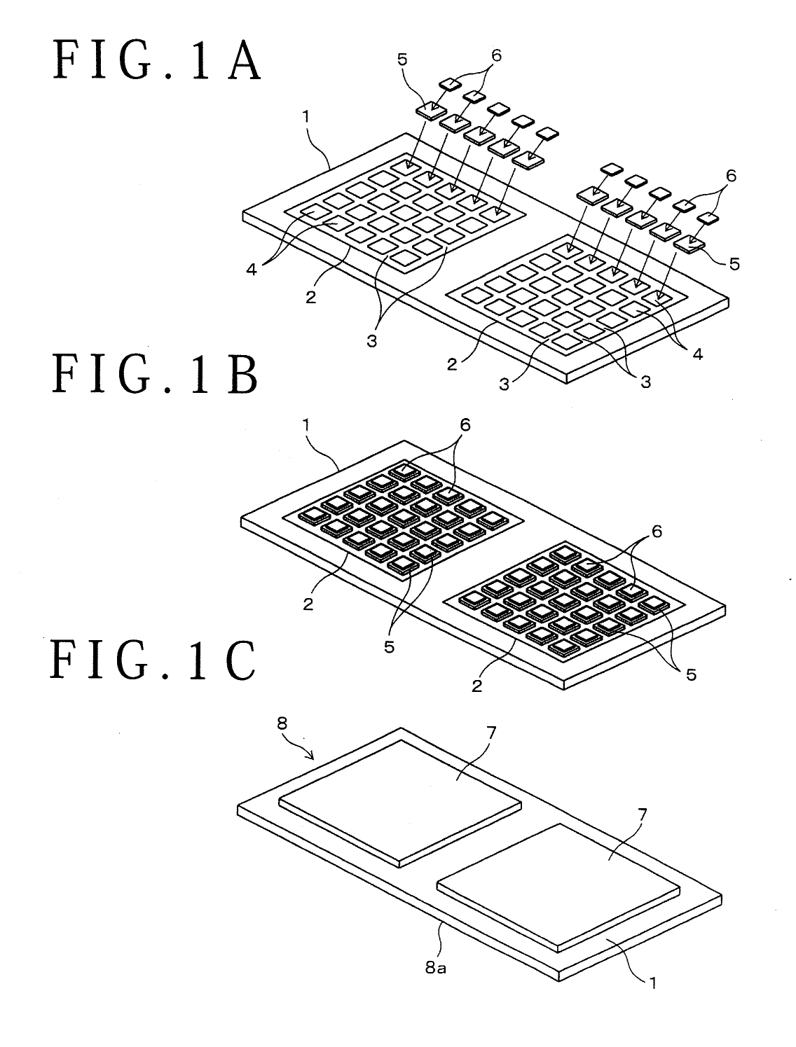

FIGS. 1A to 1C show a fabrication procedure for a package base according to the present invention, wherein reference numeral 1 denotes a rectangular substrate for semiconductor packages. As shown in FIG. 1A, the front surface (upper surface) of the substrate 1 is formed with a plurality of (two in this preferred embodiment) rectangular chip mounting areas 2. Each chip mounting area 2 is partitioned by a plurality of crossing cutting lines 3 to define a plurality of chip stacking portions 4 arranged like a matrix. A package base 8 shown in FIG. 1C is fabricated in the following manner. First, a first semiconductor chip 5 and a second semiconductor chip 6 are stacked and bonded on each chip stacking portion 4 of the substrate 1 as shown in FIGS. 1A and 1B, and electrical connection is made between the chips 5 and 6 and between the chips 5 and 6 and the substrate 1. Thus, all the chips 5 and 6 are mounted on each chip mounting area 2 of the substrate 1 as shown in FIG. 1B.

Thereafter, a molding die (not shown) is set so as to enclose each chip mounting area 2 of the substrate 1, and a liquid resin is charged into the molding die and then solidified. The molding die is a rectangular thin case having a shape and size corresponding to the shape and size of each chip mounting area 2. After solidifying the resin in the molding die, the solid resin is released from the molding die to obtain the package base 8 shown in FIG. 1C. As shown in FIG. 1C, the package base 8 has two resin moldings 7 each encapsulating the semiconductor chips 5 and 6 (invisible in FIG. 1C) stacked on the substrate 1.

### [2] Configuration of Water Jet Cutting Device

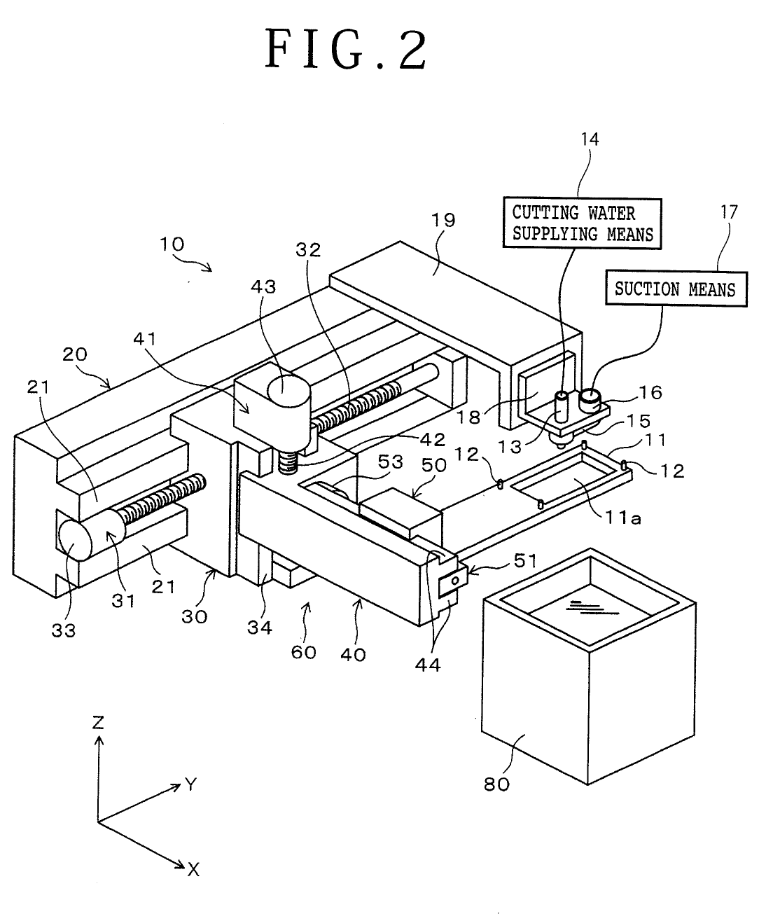

FIG. 2 shows a water jet cutting device 10 according to the preferred embodiment. In FIG. 2, two horizontal directions orthogonal to each other are shown by arrows X and Y (X and Y axes), and a vertical direction is shown by an arrow Z (Z axis). The water jet cutting device 10 includes a holding table (holding means) 11 for holding the substrate 1 and a jet nozzle (nozzle) 13 for directing a water jet (high-pressure cutting water containing abrasive powder) toward the substrate 1 held by the holding table 11, thereby cutting the substrate 1. The holding table 11 is movable in the X, Y, and Z directions, and the jet nozzle 13 is fixed.

The holding table 11 is mounted through an XYZ moving mechanism (jet position moving means) 60 to a fixed base 20 having a rectangular parallelepiped shape extending in the Y direction. The XYZ moving mechanism 60 is composed of a Y-axis moving base 30, Z-axis moving base 40, and X-axis moving base 50. A pair of guide rails 21 are formed on one side surface of the fixed base 20 so as to extend in the longitudinal direction (Y direction). The Y-axis moving base 30 is mounted on the guide rails 21 so as to be slidable in the Y direction.

The Y-axis moving base 30 is moved in the Y direction along the guide rails 21 by a Y-axis moving mechanism 31. The Y-axis moving mechanism 31 is provided between the guide rails 21, and it is composed of a screw rod 32 rotatably supported to the fixed base 20 and extending in the Y direction and a pulse motor 33 for rotating the screw rod 32 in both forward and reverse directions. The screw rod 32 is threadedly engaged with the Y-axis moving base 30 so as to extend therethrough. The screw rod 32 is rotatable, but axially unmovable. Accordingly, when the pulse motor 33 of the Y-axis moving mechanism 31 is operated in the forward or reverse direction to rotate the screw rod 32, the Y-axis moving base 30 is moved along the guide rails 21 in the Y direction corresponding to the direction of rotation of the screw rod 32.

The Z-axis moving base 40 is mounted on the Y-axis moving base 30, and the X-axis moving base 50 is mounted on the Z-axis moving base 40 respectively. The mounting structures of the Z-axis moving base 40 and the X-axis moving base 50 are similar to the above-mentioned mounting structure of the Y-axis moving base 30 to the fixed base 20. Further, the mechanisms for moving the Z-axis moving base 40 and the X-axis moving base 50 are also similar to the above-mentioned moving mechanism for the Y-axis moving base 30.

More specifically, the Z-axis moving base 40 is slidably mounted on a pair of guide rails 34 formed on the Y-axis moving base 30 so as to extend in the Z direction. The Z-axis moving base 40 is moved in the Z direction along the guide rails 34 by a Z-axis moving mechanism 41. The Z-axis moving mechanism 41 is composed of a screw rod 42 and a pulse motor 43. The screw rod 42 is rotatably supported to the Y-axis moving base 30 and is threadedly engaged with the Z-axis moving base 40 so as to extend therethrough in the Z direction. The pulse motor 43 functions to rotate the screw rod 42 in both forward and reverse directions. Accordingly, when the screw rod 42 is rotated by the pulse motor 43, the Z-axis moving base 40 is moved (raised or lowered) in the Z direction corresponding to the direction of rotation of the screw rod 42.

The X-axis moving base 50 is slidably mounted on a pair of guide rails 44 formed on the Z-axis moving base 40 so as to extend in the X direction. The X-axis moving base 50 is moved in the X direction along the guide rails 44 by an X-axis moving mechanism 51. The X-axis moving mechanism 51 is composed of a screw rod (not shown) and a pulse motor 53. This screw rod is rotatably supported to the Z-axis moving base 40 and is threadedly engaged with the X-axis moving base 50 so as to extend therethrough in the Y direction. The pulse motor 53 functions to rotate this screw rod in both forward and reverse directions. Accordingly, when this screw rod is rotated by the pulse motor 53, the X-axis moving base 50 is moved in the X direction corresponding to the direction of rotation of this screw rod.

The holding table 11 mentioned above is a rectangular plate extending in the Y direction, and it is mounted on one side surface of the X-axis moving base 50 opposite to the side surface mounted to the Z-axis moving base 40. A rectangular mounting hole 11a extending in the Y direction is formed through a front end portion of the holding table 11, and four positioning pins 12 are formed near the four corners of the mounting hole 11a so as to project upward. The substrate 1 is positioned on the holding table 11 by using the positioning pins 12, and is moved together with the holding table 11 in the X, Y, and Z directions by the XYZ moving mechanism 60. The positioning of the substrate 1 is performed by using a jig (not shown) adapted to hold the substrate 1 and be detachably mounted to the positioning pins 12.

The jet nozzle 13 is provided above the holding table 11 so as to direct a water jet downwardly in the vertical direction. The jet nozzle 13 is connected to cutting water supplying means 14, so that a high-pressure cutting water is supplied from the cutting water supplying means 14 to the jet nozzle 13, thereby directing a water jet from the jet nozzle 13 toward the substrate 1 held on the holding table 11. Further, a duct 15 having a dome shape extending in the horizontal direction and opening to the holding table 11 is provided in the vicinity of the jet nozzle 13. The duct 15 is provided with a duct pipe 16 arranged adjacent to the jet nozzle 13. The duct pipe 16 is connected to suction means 17. The suction means 17 functions to suck the cutting water in its mist state caused by the diffusion of the water jet directed from the jet nozzle 13, through the duct 15 and the duct pipe 16. The jet nozzle 13 and the duct 15 are fixed through a bracket 18 and a nozzle supporting arm 19 to the fixed base 20.

By operating the X-axis moving mechanism 51 and the Y-axis moving mechanism 31 to move the holding table 11 in the X direction and the Y direction, the jet position of the water jet from the jet nozzle 13 to the substrate 1 held on the holding table 11 can be adjusted. On the other hand, by operating the Z-axis moving mechanism 41 to move the holding table 11 in the Z direction, the jet distance of the water jet from the jet nozzle 13 to the substrate 1 held on the holding table 11 can be adjusted.

Further, a buffer tank 80 for receiving the water jet directed from the jet nozzle 13 is provided below the holding table 11. The buffer tank 80 contains water for reducing the intensity of the water jet. The water in the buffer tank 80 is discharged by drainage means (not shown) to always maintain a constant water level.

### [3] Cutting Method for Package Base by Using Water Jet Cutting Device

Having thus described the configuration of the water jet cutting device 10, a cutting method for the package base 8 by using the water jet cutting device 10 according to the preferred embodiment will now be described with reference to FIGS. 2 to 4B.

### (I) Primary Cutting Step

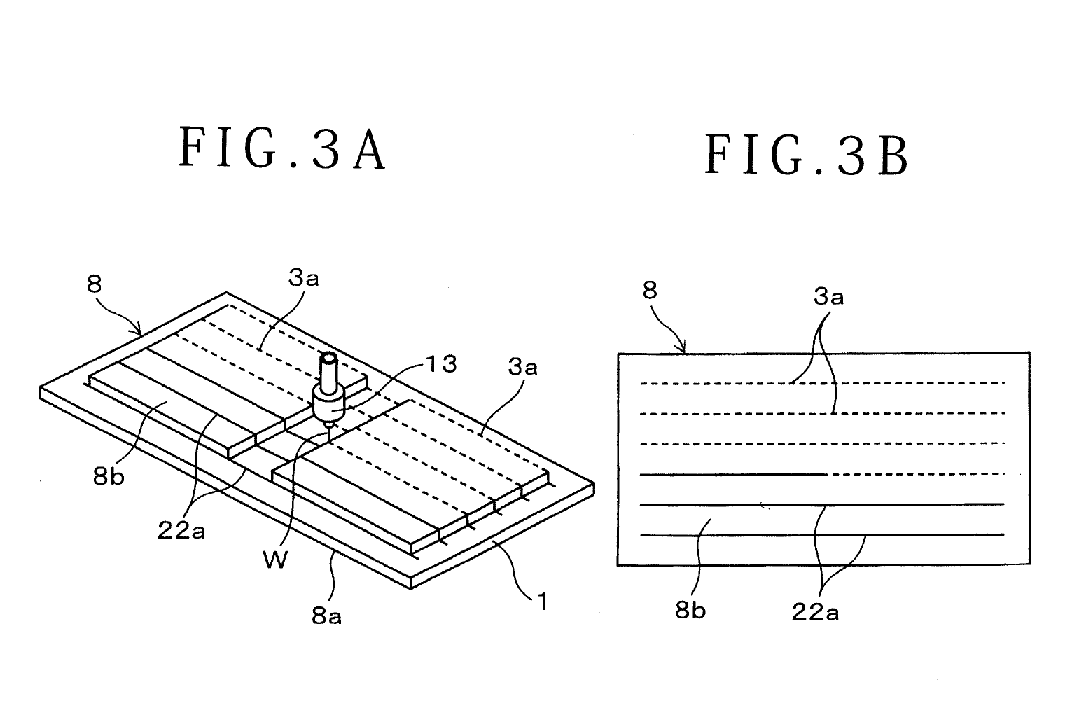

The package base 8 is positioned by the positioning pins 12 and set on the holding table 11 in the condition that the longitudinal direction of the package base 8 is parallel to the Y direction. In the primary cutting step, as shown in FIGS. 3A and 3B, a plurality of primary subject lines 3a to be cut in the primary cutting step extend parallel to each other in the longitudinal direction of the package base 8, i.e., in the Y direction. The Y-axis moving base 30 and the X-axis moving base 50 of the XYZ moving mechanism 60 are suitably moved to thereby move the package base 8 to a cutting area below the jet nozzle 13 and to next adjust the jet position of a water jet W to be directed from the jet nozzle 13 to one end of one of the plural primary subject lines 3a as a cutting start point. Thereafter, the Z-axis moving base 40 is suitably moved to thereby adjust the jet distance from a nozzle hole 13a formed at the lower end of the jet nozzle 13 to the package base 8.

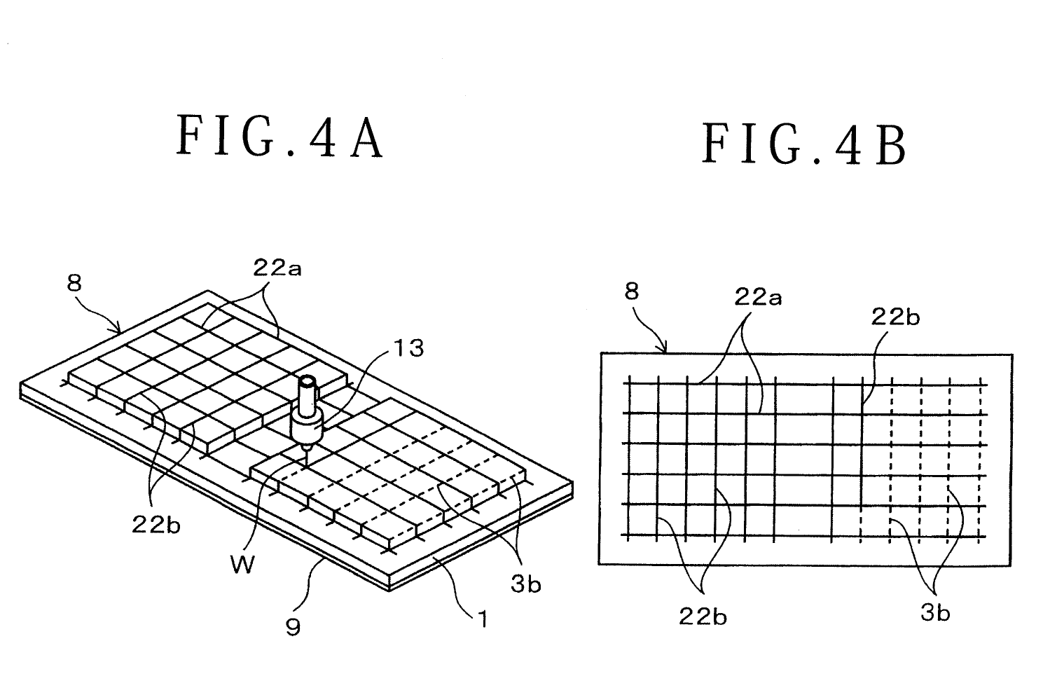

As the primary subject line 3a to be first cut, one of the two outermost ones of the plural primary subject lines 3a extending parallel to each other is selected in this preferred embodiment. Further, the opposite ends of this primary subject line 3a to be first cut are set as a cutting start point and a cutting stop point. As shown in FIGS. 4A and 4B, these cutting start and stop points of each primary subject line 3a are set outside of the two outer ones of a plurality of secondary subject lines 3b orthogonal to the primary subject lines 3a. Similarly, the opposite ends of each secondary subject line 3b are set outside of the two outermost ones of the plural primary subject lines 3a. In other words, the cutting start and stop points of each of the primary and secondary subject lines 3a and 3b are set outside of the rectangular cutting area of the package base 8 as defined by the two outermost primary subject lines 3a and the two outermost secondary subject lines 3b.

Thereafter, the cutting water supplying means 14 is operated to direct the cutting water from the jet nozzle 13 at a predetermined pressure. That is, the water jet W as the jet form of the cutting water is directed from the jet nozzle 13 to the cutting start point of the primary subject line 3a to be first cut, thereby forming a through hole cut through the thickness of the package base 8 at the cutting start point. At the same time, the suction means 17 is also operated to suck from the duct 15 the cutting water in its mist state caused by the diffusion of the water jet W and the substrate material in its particle state caused by the cutting. After the water jet W cuts through the package base 8 at the cutting start point, the Y-axis moving base 30 is moved in the Y direction to thereby form a primary cut line 22a corresponding to the first primary subject line 3a as shown in FIG. 3A. When the water jet W reaches the cutting stop point to fully cut the first primary subject line 3a, the supply of the cutting water is once stopped.

Thereafter, the X-axis moving base 50 is moved to thereby target the water jet W to the cutting start point of the second primary subject line 3a adjacent to the first primary cut line 22a (corresponding to the first primary subject line 3a). At this cutting start point of the second primary subject line 3a, the supply of the cutting water is restarted to direct the water jet W from the jet nozzle 13 again, and the Y-axis moving base 30 is moved to cut the second primary subject line 3a until the cutting stop point. This cutting operation is repeated for the other primary subject lines 3a to thereby form a plurality of similar primary cut lines 22a. All of the primary subject lines 3a are equally spaced, so that all of the primary cut lines 22a are equally spaced. As a result, as shown in FIGS. 3A and 3B, a plurality of primary cut areas 8b (one of which being shown) having the same size and shape are obtained and each primary cut area 8b is integrated at its opposite ends with the package base 8. That is, each primary cut area 8b is supported at its opposite ends to the package base 8.

### (II) Adhesive Member Attaching Step

After the primary cutting step, or after finishing the cutting of all the primary subject lines 3a, the package base 8 is moved to a standby area by the XYZ moving mechanism 60. Thereafter the package base 8 is removed from the holding table 11, and an adhesive member is attached to the lower surface 8a of the package base 8. In this preferred embodiment, a dicing tape 9 is used as the adhesive member. The dicing tape 9 is composed of a base film formed of synthetic resin such as acrylic resin and an adhesive layer coated on one side surface of the base film. This adhesive layer has an adhesive strength decreasing by irradiation with ultraviolet light. Any other members may be used as the adhesive member instead of the dicing tape 9 provided that the adhesive member does not interfere with the cutting of the package base 8 in the secondary cutting step to be performed later and can prevent the drop of cut portions of the package base 8 obtained after the secondary cutting step.

### (III) Secondary Cutting Step

After the dicing tape 9 is attached to the lower surface 8a of the package base 8, the package base 8 is set again on the holding table 11 of the water jet cutting device 10 as in the primary cutting step. Thereafter, the Y-axis moving base 30 and the X-axis moving base 50 of the XYZ moving mechanism 60 are suitably moved to thereby move the package base 8 to the cutting area below the jet nozzle 13. Further, the jet position of the water jet W to be directed from the jet nozzle 13 is adjusted to the cutting start position where the secondary cutting is started. As the secondary subject line 3b to be first cut in the secondary cutting step, one of the two outermost ones of the plural secondary subject lines 3b extending parallel to each other is selected in this preferred embodiment.

Thereafter, the cutting water is directed as the water jet W from the jet nozzle 13 to the package base 8 at the cutting start point of the secondary subject line 3b to be first cut, thus starting the secondary cutting for the package base 8 as similarly to the first cutting step. Thereafter, the X-axis moving base 50 is moved in the X direction to thereby form a secondary cut line 22b corresponding to the first secondary subject line 3b as shown in FIG. 4A. When the water jet W reaches the cutting stop point to fully cut the first secondary subject line 3b, the supply of the cutting water is once stopped. Thereafter, the Y-axis moving base 30 is moved to thereby target the water jet W to the cutting start point of the second secondary subject line 3b adjacent to the first secondary cut line 22b (corresponding to the first secondary subject line 3b). At this cutting start point of the second secondary subject line 3b, the supply of the cutting water is restarted to direct the water jet W from the jet nozzle 13 again, and the X-axis moving base 50 is moved to cut the second secondary subject line 3b until the cutting stop point, thus forming a second secondary cut line 22b adjacent to the first secondary cut line 22b. This cutting operation is repeated for the other secondary subject lines 3b to thereby form a plurality of similar secondary cut lines 22b.

After finishing the cutting of all the secondary subject lines 3b, the package base 8 is moved to the standby area by the XYZ moving mechanism 60. Having thus described cutting method for the package base 8 by using the water jet cutting device 10 according to this preferred embodiment, this cutting method is repeated for many similar package bases 8 to obtain numerous semiconductor packages each having a predetermined size cut from each package base 8. The operation of the XYZ moving mechanism 60 and the operation of directing the water jet W from the jet nozzle 13 are suitably controlled by control means (not shown). The control means preliminarily stores necessary data for the above operations and performs the control according to the stored data. After the secondary cutting step, the dicing tape 9 is irradiated with ultraviolet light to reduce the adhesive strength of the dicing tape 9. Thereafter, the individual semiconductor packages are picked up from the dicing tape 9. While the package base 8 is cut along the cutting lines 3 extending in the Y direction in the primary cutting step and next cut along the cutting lines 3 extending in the X direction in the secondary cutting step in this preferred embodiment, the order of this cutting operation may be reversed. Also in this case, an effect similar to that of the above preferred embodiment can be obtained.

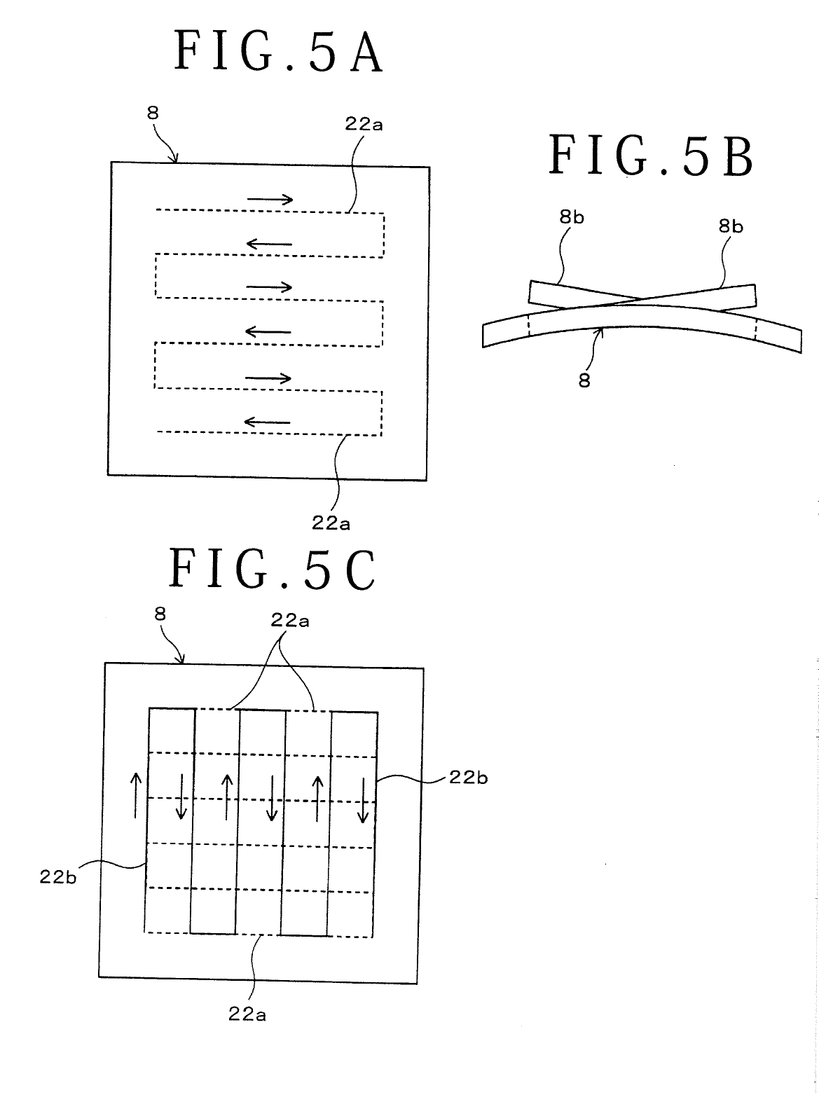

FIGS. 5A to 5C show a conventional cutting method for the package base 8. As shown in FIGS. 5A to 5C, each of the two cutting steps is performed like a single-stroke drawing as shown by the arrows. Accordingly, as shown in FIG. 5B, the package base 8 after the primary cutting step shown in FIG. 5A suffers warping because of a stress originally existing in the package base 8, so that each primary cut area 8b is supported at its one end to the package base 8 to project in the direction substantially along the thickness of the package base 8. In the case that the adhesive member attaching step and the secondary cutting step are next performed in the condition of the package base 8 shown in FIG. 5B, there is a possibility of occurrence of various troubles such as an error in transporting the package base 8 and an error in attaching the adhesive member. Further, there is a possibility that the accuracy of cutting in the secondary cutting step may be reduced in the warped condition of the package base 8.

To the contrary, each primary cut area 8b according to this preferred embodiment is supported at its opposite ends to the package base 8 as shown in FIG. 3B. Accordingly, the warping of the package base 8 can be prevented, so that the projection of each primary cut area 8b from the package base 8 can be prevented. As a result, various troubles in the prior art as mentioned above can be prevented, so that the adhesive member attaching step and the secondary cutting step can be efficiently performed. Further, since the warping of the package base 8 after the primary cutting step can be prevented, the cutting accuracy in the secondary cutting step can be improved to thereby obtain semiconductor packages with a desired accuracy.

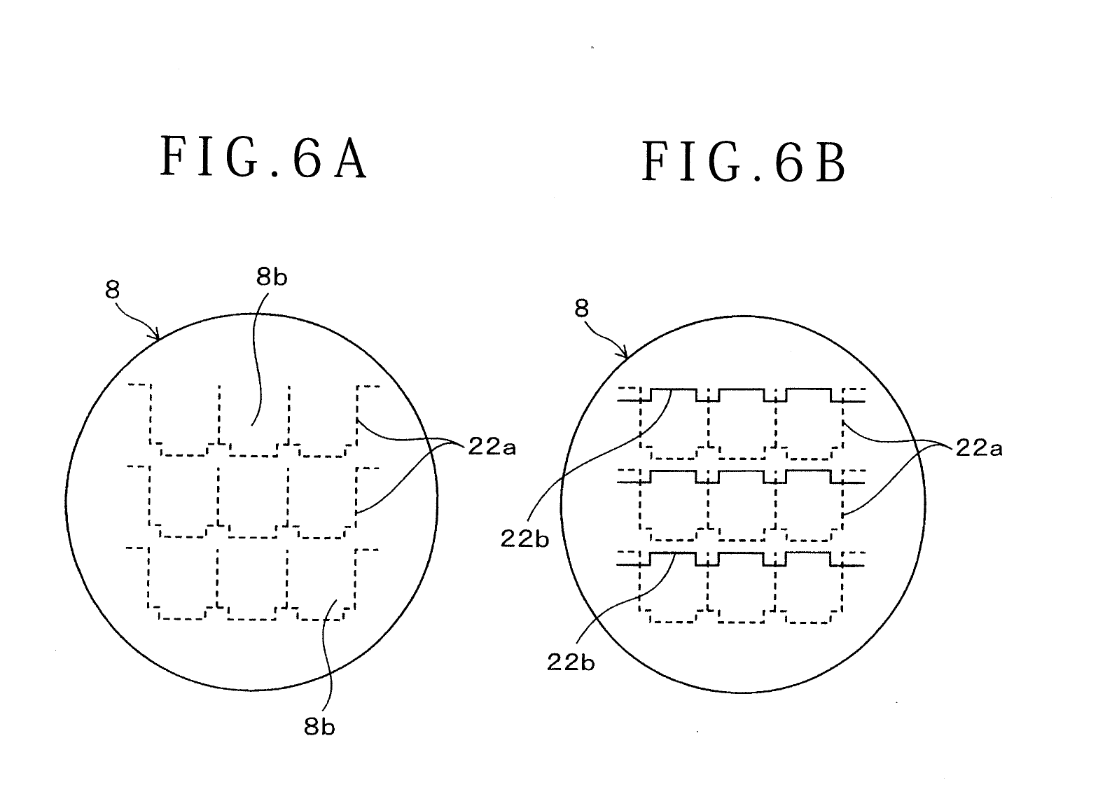

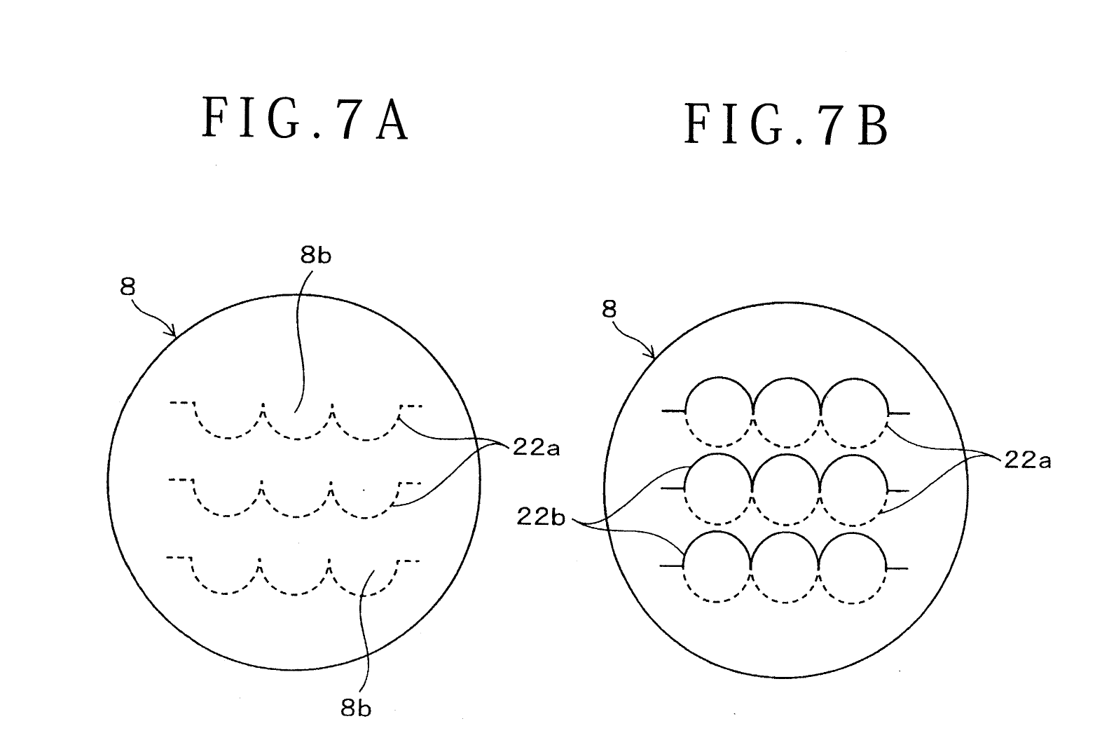

FIGS. 6A and 7A show modifications of the primary cut lines 22a after the primary cutting step. In each modification, the primary cut area 8b is supported at its one end to the package base 8. As compared with each primary cut area 8b shown in FIG. 3B, each primary cut area 8b shown in FIGS. 6A and 7A projects from the package base 8. However, each primary cut area 8b shown in FIGS. 6A and 7A has a size corresponding to the size of each semiconductor package and has a relatively short length. Accordingly, the degree of warping and projection of each primary cut area 8b can be suppressed as compared with the prior art shown in FIG. 5B. As a result, also in these modifications, various troubles in the prior art can be suppressed. After the primary cutting step, the dicing tape 9 is attached to the lower surface of the package base 8 as in the above preferred embodiment, and the secondary cutting step is next performed to form the secondary cut lines 22a (shown by solid lines) as shown in FIGS. 6B and 7B. Accordingly, it is possible to obtain semiconductor packages with a desired accuracy as similar to the above preferred embodiment. Thus, according to the cutting method of the present invention, the package base 8 can be efficiently cut along the cutting lines 3 to obtain a plurality of partitioned portions having the same shape and size with a desired accuracy.

Further, since the cutting start and stop points are set outside of the cutting area as shown in FIG. 4B, the influence of erosion on the semiconductor packages can be suppressed. At the cutting start and stop points, the time for jetting of the cutting water is relatively long, so that the influence of erosion at the cutting start and stop points may become larger than that at the other points on each cutting line. Further, if the semiconductor packages are influenced by erosion, the value of the semiconductor packages as products may be reduced to invite the production of defective pieces. To cope with this problem, the cutting start and stop points are set outside of the cutting area according to this preferred embodiment to thereby suppress the influence of erosion on the semiconductor packages, thus improving the yield.

The present invention is not limited to the details of the above described preferred embodiments. The scope of the invention is defined by the appended claim and all changes and modifications as fall within the equivalence of the scope of the claims are therefore to be embraced by the invention.

What is claimed is:

1. A water jet cutting method using a water jet cutting device including holding means for holding a platelike workpiece, cutting water supplying means for supplying a high-pressure cutting water, a nozzle for jetting said cutting water supplied from said cutting water supplying means toward said workpiece held by said holding means, and jet position moving means for relatively moving said nozzle and said holding means to change a jet position of said cutting water jetted from said nozzle onto said workpiece, wherein a plurality of straight and/or curved cutting lines are set on said workpiece, and said workpiece is cut along said cutting lines by jetting said cutting water from said nozzle and operating said jet position moving means, thereby obtaining a plurality of partitioned portions having the same shape and size, said cutting method comprising:
a primary cutting step for cutting said workpiece along a first group of said cutting lines to form a plurality of primary cut areas having the same shape and size in the condition where at least one end of each primary cut area is integrally supported to said workpiece;
an adhesive member attaching step for attaching an adhesive member to one side surface of said workpiece; and
a secondary cutting step for cutting said primary cut areas along the other group of said cutting lines to obtain said partitioned portions.
